(19) United States
(12) Patent Application Publication
(10) Pub. No.: US 2003/0112996 A1
(43) Pub. Date: Jun. 19, 2003

(54) Automatic monitoring of host signal quality using embedded data

(76) Inventors: Matthew J. Holliman, Sunnyvale, CA (US); Minerva M. Yeung, Sunnyvale, CA (US)

Correspondence Address: John P. Ward, BLAKELY, SOKOLOFF, TAYLOR & ZAFMAN LLP, 12400 Wilshire Boulevard, Seventh Floor, Los Angeles, CA, 90025-1026, US

(21) Appl. No.: 10/028,470

(22) Filed: Dec. 19, 2001

(51) Int. Cl. G06K 9/00

(52) U.S. Cl. 382/100

(57) ABSTRACT

Dynamic monitoring and correction of network or transcoding service quality is accomplished by use of watermarking techniques that allow accurate spatial and temporal localization of degraded or corrupted data sets without requiring access to an original source data set. Damage to watermarks, corresponding to damage to a data set in which the watermark is embedded, can be reported to a data processor to permit near real time modifications to data bandwidth or encoding techniques to reduce further data corruption.

### TECHNICAL FIELD OF THE INVENTION

The present invention relates to monitoring signal quality of transmitted media. More specifically, this invention provides automatic quality assessment of network transmitted audiovisual material using digital watermarking or other data embedding techniques.

### BACKGROUND ART

Multimedia services supporting manipulation, downloading, and streaming transmission of compressed multimedia content over both wired and wireless internetworks are attracting widespread interest of content providers, network service providers, and end consumers. Despite such interest in the deployment of media services, the current infrastructure does not yet fully and seamlessly support such capabilities. For example, although QoS (quality of service) has been an active area of research in recent years, bandwidth requirements are not yet guaranteed by today's ‘best-effort’ packet networks such as the public Internet, and in fact are even more variable in emerging wireless. As a result, streamed video/audio quality over present packet-based network connections can vary wildly based on factors such as link conditions, e.g. network congestion, or the service provider's bandwidth capacity.

While in some applications the content quality can be improved by retransmission of content following packet loss or other bit errors, this increases network latency and congestion, and may introduce substantial local memory buffering delays. In streaming applications, frequent buffering disrupts the continuity of the viewing experience, which despite improved rendered quality attributable to retransmission may actually result in a poorer perceived user experience (as compared to smoother playback with greater visual artifacts). In certain viewing scenario typically associated with mobile devices, even memory buffering may be severely limited or even impractical due to memory constraints on the device. For these reasons, in streaming scenarios, it is expected that the effects of packet loss are likely to be observed in received content. In addition to conventional data loss from network errors, streaming media may also be subject to data loss as a result of data conversions. As content is delivered to devices of diverse capabilities, such transcoding and format conversions will become increasingly commonplace Such potential degradation of content introduces problems for content providers, network carriers, and end users. In comparison to typical TCP or HTTP-based downloaded data, received media content may arrive with varying degrees of quality.

To provide information related to the various data loss hazards expected in network streamed media, use of various quality of service mechanisms for quantifying the data loss are known. For example, one simple means of estimating content quality is to use the received bandwidth of the content as a quality metric, and expect better quality of service for a 300 Kb/s stream vs. a 200 Kb/s stream. Although easy to implement on the client side, this approach is inadequate because it fails to take into account the impact of network problems such as transient packet losses or high frequency variations in available bandwidth.

Another possibility for measuring quality in a lossy network environment is to monitor packet losses at the client side, and to use these as an indicator of the quality of the received content. However, this fails to take into account any quality loss introduced by transcoding or by a poor initial encoding. Furthermore, even if a high quality original is used for streaming, packet loss by itself is not necessarily a reliable indicator of received content quality. For example, dropped or corrupted packets in key frames (I-frames in the MPEG standards, which are typically used as the basis to predict approximately the next dozen frames) are typically far more catastrophic than errors in predicted frames (e.g. B-frames in the MPEG family of standards, in which errors do not propagate in a video's temporal dimension).

A final possibility is to attempt to estimate reconstructed content quality at the client side, e.g. by performing automatic edge detection. However, this approach suffers from the fact that the client does not have access to the original content and can thus not necessarily quantify the extent of any degradations. Furthermore, the computing power available at typical handheld devices is limited at present, and so complexity requirements are likely to be prohibitive amongst a diverse collection of target devices. As an alternative, the client could send a short description of the received content back to the server via an RTCP-like back-channel, e.g. describing certain salient points in the image, which the server could compare to the same features on the original content. However, this requires additional bandwidth, introduces a heavy computation burden on the server, and also does not necessarily capture all image degradations observed at the client side.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 generically illustrates a process for employing watermarking to measure quality of network service with respect to received data;

FIG. 2 illustrates impact of packet loss on transmitted multimedia data;

FIG. 3 is a example of an image after spatially embedding a watermark over the image, and before compression for transmission over a lossy network;

FIG. 4 is an example of the image of FIG. 3 reconstructed after suffering data degradation, with dark blocks representing data loss or corruption;

FIG. 5 is illustrates the partial reconstruction of the embedded watermark, with dark blocks representing data loss or corruption;

FIG. 6 illustrates distortion dependent watermark embedding; and

FIGS. 7-9 are flow diagrams illustrating various applications.

### DETAILED DESCRIPTION

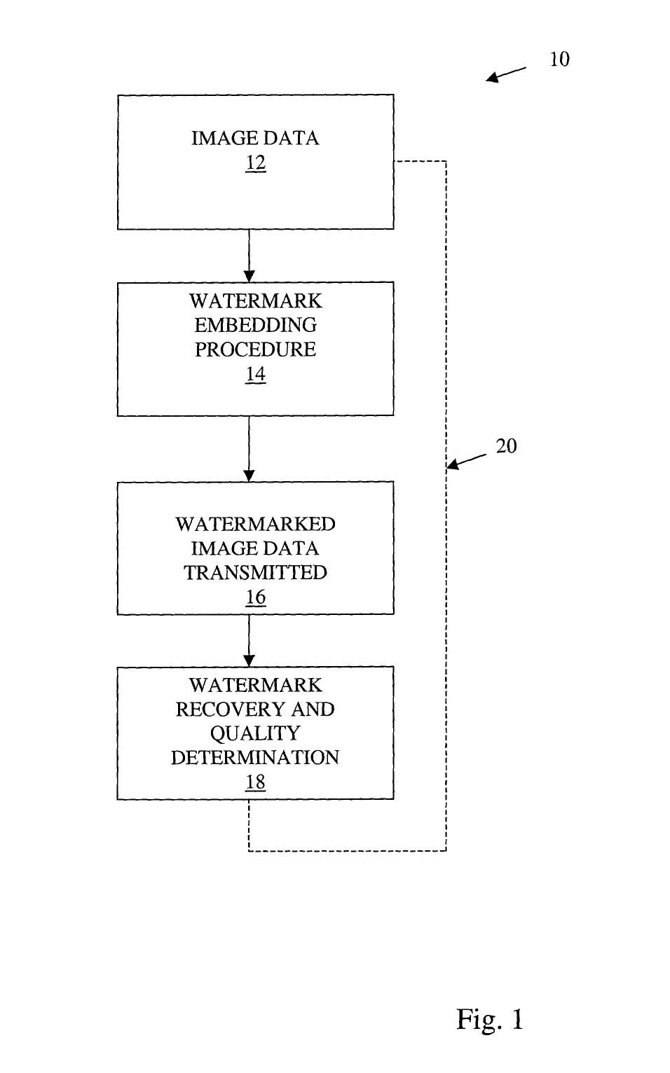

As seen with respect to the block diagram of FIG. 1, the present invention is a system 10 that aids in implementation of a quality of service monitoring system over a transiently or intermittently unreliable communication channel. The communication channel can be wired or wireless, packet or non-packet based, and can utilize commonly available control and transmission protocols, including those based on TCP/IP, 80211.a, or Bluetooth.

While the data can be any commonly available computer processed data, typically transmitted data is bandwidth intensive image, audio, or audiovisual data (image data 12). The image data 12 can be normally encoded for transmission as MPEG2, MPEG4, JPEG, Motion JPEG, or other sequentially presentable transform coded images. Because of the substantial data volume of uncompressed video streams, standard discrete cosine transform based quantization can be used for signal compression, although other compression schemes may also be used. In the illustrated embodiment of FIG. 1, the quality of service tracking relies on a watermark embedding 14 into the image data, followed by data transmission 16, and watermark recovery and analysis 18. If the recovered watermark is not intact, the receiver can quantitatively determine quality degradation. An optional back channel 20 can be used to send information relating to signal quality back to a provider of image data, allowing near real time correction (by increasing bandwidth, for example) if quality of service parameters are not met. Generally, digital watermarking (block 14 of FIG. 1) is a means of embedding information within a piece of content, e.g. a video, audio clip, or still image, such that it is imperceptible to a human observer, but can be recovered by an authorized detector. Commonly cited applications of watermarking include copyright notification, recipient tracing, and copy protection.

An important requirement of digital watermarking systems is that as long as a piece of watermarked content remains usable within some given ‘bounds,’ the watermark information should be recoverable. Conversely, once content becomes degraded beyond the point of usability, watermark information is typically no longer recoverable. For reasons of reliability, unwatermarked content should also result in no watermark information being recovered. The precise meaning of ‘usability’ depends on a particular application. For copy protection and fingerprinting scenarios, the watermark must be robust to almost any operation the host signal can be expected to undergo. In contrast, for authentication scenarios, a watermark may be designed to break upon absolutely any modification (‘fragile’ watermarking), lossy compression (‘semi-robust’ watermarking), etc. Finally, in many cases, watermarks can be localized within content; i.e., if a particular segment of content is corrupted or degraded, only the corresponding portion of the watermark is damaged.

According to the present invention, such properties of typical watermarks can be used as a measure of received content quality. If content is received at a quality comparable to the original, by definition, an embedded watermark should be recoverable. In contrast, if packet losses or other transmission errors occur, or if the stream is transmitted at a lower bitrate, the reconstructed content is typically degraded in quality, and a recovered watermark should likewise be degraded. This allows content providers and/or network service providers to more precisely localize and characterize the extent of degradations to content. For example, using this information, an end user may be billed using a sliding scale based on the quality of service the consumer experiences.

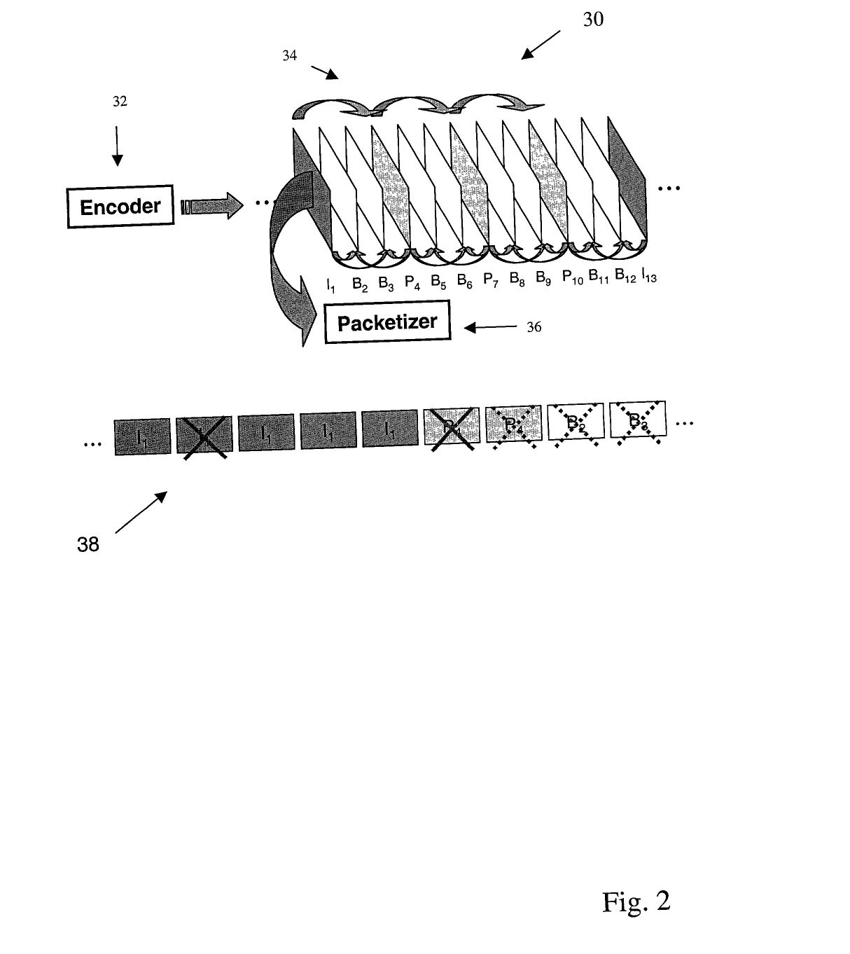

Digital watermarking techniques can overcome the problem, as seen with respect to FIG. 2, of the complex mapping between a video frame and its packetized components. In FIG. 2 an encoding and packetizing system 30 for MPEG style coding includes an encoder 32 for converting an analog video signal into a series of digital images 34 consisting of a series of I, B, and P frames. This frame information is packetized for transmission by packetizer 36. Since an I-frame is typically fairly large as compared to packet size, it is generally split up over several packets. Lost packets (indicated by X's and dotted X's in the packet blocks 38) can have varying effects on image quality, with certain packet losses (the dotted X's) having less impact on quality than other loss of I or P frame packets (X's).

Simply equating packet loss to quality loss is generally inadequate, not only because of the differential value of packet data from different frame types, but because of the differential value of data derived from some regions of the video frame (e.g. the difference between highly textured areas compared to a featureless background region. To measure intraframe quality using packet loss information alone would require much greater complexity in a streaming system that is required to support such a mapping. Furthermore, such operations as repacketization or transcoding would require recalculation of packet weights, a computationally expensive task. Finally, including a measure of packet significance does not address occasional bit errors within packets, which may or may not be correctable and which can adversely impact the successful decoding of media data within the packet payload. Bit errors are typically not an issue in conventional wired networks, but may be more problematic in wireless applications.

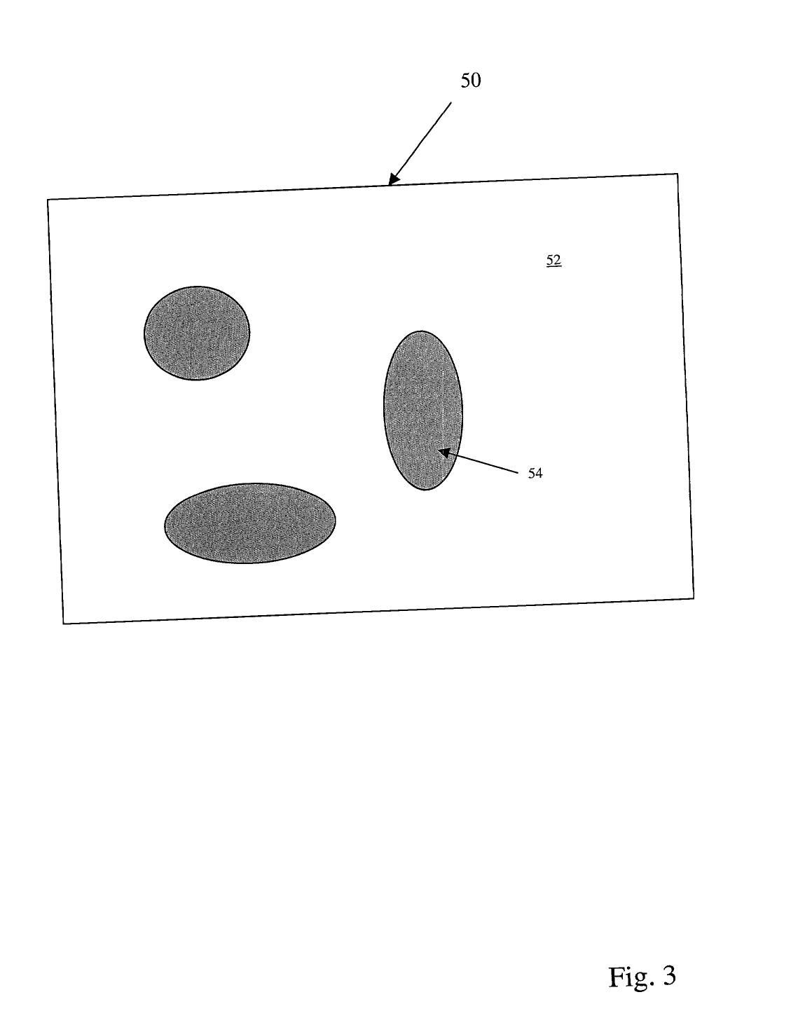

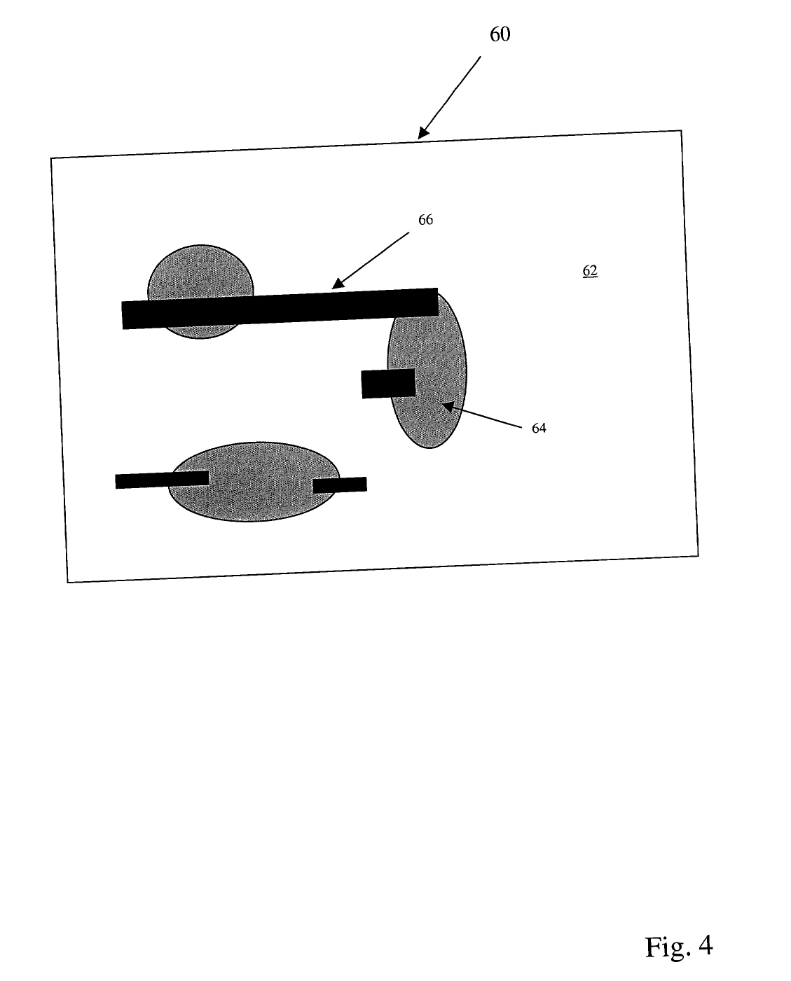

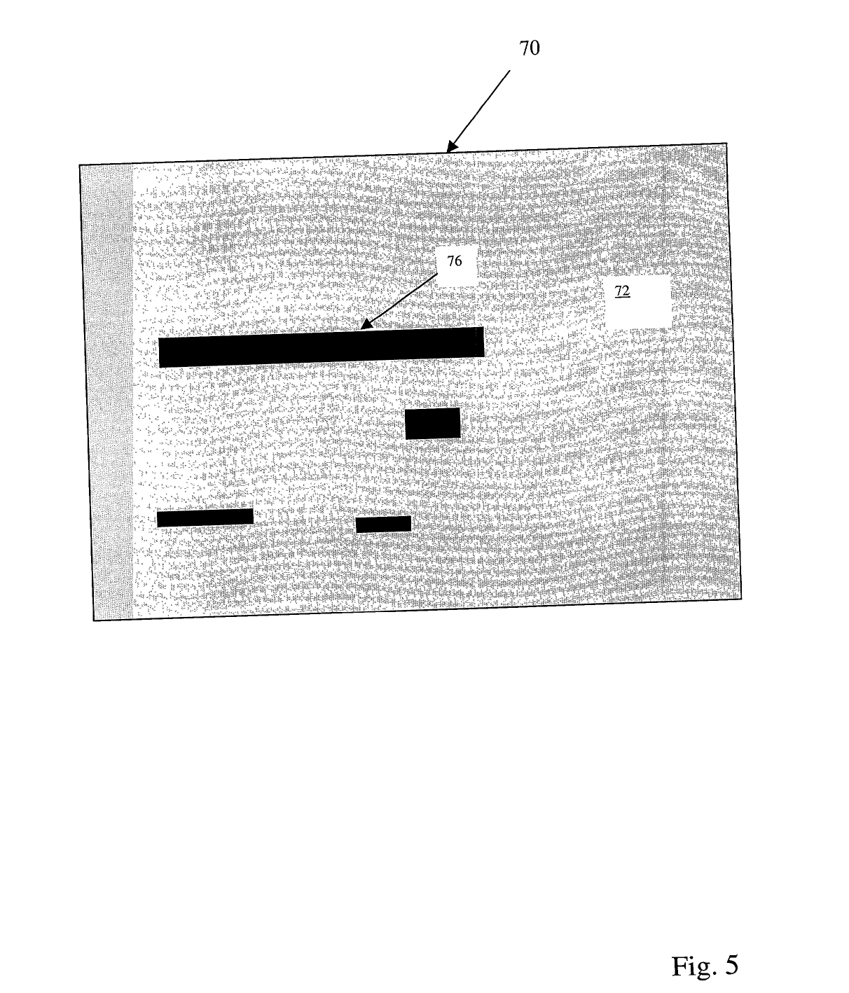

As seen with respect to FIGS. 3, 4, and 5, digital watermarks can be used for error localization within image frames. FIG. 3 is a example of an image 50 after spatially embedding a watermark over the image, and before compression for transmission over a lossy network. This simple image consists of a background 52 and several oval shapes 54. FIG. 4 is an image 60 reconstructed after suffering data loss during transmission over a network, with dark blocks 66 extending through the background 62 and ovals 64 representing data loss or corruption. FIG. 5 is illustrates the partial reconstruction of the embedded watermark 70 from that image, with dark blocks 76 being damaged watermarks position correlated with image damage, and background 72 being undamaged watermark position correlated with undamaged image.

In the particular case of streaming scenarios, watermarks for content quality monitoring do not have the same security requirements as, say, typical content protection or authentication watermarks. This is a direct consequence of the fact that, by definition, they apply to real-time transmission of content and not content stored in any kind of persistent state. Thus, many quality monitoring detectors need not cope with more problematic distortions such as translation, scaling, digital-analog (D/A) conversion, etc. In a similar manner, watermark security in terms of counterfeiting, removal, etc. is not an issue. This greatly simplifies watermarking algorithm design, and allows for fast, light-weight detectors in client-side players. The principal requirements of such a system are that (1) the watermark must be at least somewhat robust to the compression format in which the video is stored, ideally with the property that the watermark degrades gracefully (e.g. linearly) as compression artifacts worsen, and (2) the watermark should degrade gracefully with increasingly severe channel errors.

One preferred method for watermark embedding is to employ a simple correlation-based technique over each video frame, either in the spatial domain or in a transform domain, such as on 8×8 DCT blocks. Most additive noise watermarking systems weight watermarks according to the corresponding local image's relative importance to the Human Visual System (HVS), so that little information is hidden in featureless areas where artifacts are readily observed, whereas more information is embedded in textured regions. That is, watermark embedding is of the form

Iₙ′=Iₙ+αₙwₙ,

where I is the original unwatermarked nth pixel or transform coefficient, aₙ is a locally adaptive non-negative weighting factor, and wₙ is a pseudo-random watermark signal.

Subsequent watermark detection proceeds by computing a decision variable d,

$$d = \frac{1}{N} {\sum }_{n} {w}_{n} {I}_{n}^{′} ,$$

which is typically compared to a decision threshold to verify the existence of the watermark w in I′, i.e. E[d_{unwatermarked}]=0, whereas E[d_{watermarked}]>>0. In particular, for a binary watermark wₙ∈{−1, 1}, E[d_{watermarked}]=mean(a). The image I′ is typically filtered, or a corrective term subtracted, to improve detection reliability. For the purpose of quality monitoring, it is the behavior of d in the presence of noise or channel errors that is of most interest. Advantageously, d degrades essentially linearly with increasing JPEG compression when applied to disjoint 8×8 DCT blocks in still images. This satisfies the first of the system requirements outlined above. The second main requirement, i.e. graceful degradation following channel errors, is also satisfied by the scheme. Consider a region Â containing R elements, which is corrupted or otherwise not decodable and in which the watermark is thus no longer recoverable. Furthermore, denote the corresponding original watermarked region as Â′, and assume that the remaining portions of the image, I′−Â′, are left unaltered by errors. In this case, the decision variable d is computed as

d=d+d_{R}+d_{I′-R′}

$$\begin{matrix}d = {d}_{ℜ} + {d}_{{I}^{′} - {ℜ}^{′}} \\ = \frac{1}{N} ( {\sum }_{n ∈ ℜ} {w}_{n} {ℜ}_{n} + {\sum }_{n ∈ {I}^{′} - {ℜ}^{′}} {w}_{n} {I}_{n}^{′} ) .\end{matrix}$$

By the linearity of the expectation operator, for a binary watermark, the expected reduction in d is

E[Δd]E[d_{R}]−E[d_{R′}]

$$\begin{matrix}E [ Δ d ] = E [ {d}_{ℜ} ] - E [ {d}_{{ℜ}^{′}} ] \\ = E [ {d}_{unwatermarked} ] - E [ \frac{1}{N} ( {\sum }_{n ∈ {ℜ}^{′}} {w}_{n} {ℜ}_{n}^{′} ) ] \\ = - \frac{R}{N} {\overline{α}}_{ℜ} .\end{matrix}$$

That is, by adapting the local watermark modulation strength a over the image, the embedder can assign a measure of value to different regions in each image. More important regions contribute proportionally more to the overall correlation sum. Furthermore, for two areas of equal visual importance, a larger region of change in one than the other would result in proportionally larger reductions in correlation. These properties satisfy the second basic requirement outlined above.

The magnitude of the decision variable therefore gives a quantifiable indication of the ‘global quality’ over a detection window for data. In order to allow independent computation of the quality metric, the watermark embedder can optionally either scale the average embedding amplitude so that the decision variable d is known to vary over a fixed range, i.e. [0.0, 1.0], or the uncorrupted value of d before transmission can be passed as side information with each frame or video sequence so that the detector can translate and scale its output accordingly.

Although described above in the context of spatial quality monitoring, temporal quality monitoring, e.g. to estimate quality degradation following frame dropping and a resultant decrease in temporal resolution, can also be achieved by gradually varying watermarks in consecutive frames, so as to achieve the desired reduction in watermark correlation over a period of several frames.

In contrast to correlation detection, which is typically used for low bit rate data embedding, quantization methods can be used for higher data rate. In certain embodiments of quantization watermarking, a series of micro costs can be embedded as data locally throughout images, e.g. one micro cost in each, say, 32′32 region. The detector then recovers and sums the embedded information in each region to determine an overall macro cost. In regions where the image has been corrupted, the watermark will be destroyed and no information will be recovered. In regions that have not been corrupted, the watermark will be recoverable, up to some desired level of robustness to compression, and the necessary cost information will be extracted. This enables a precise, localized quality assessment over content.

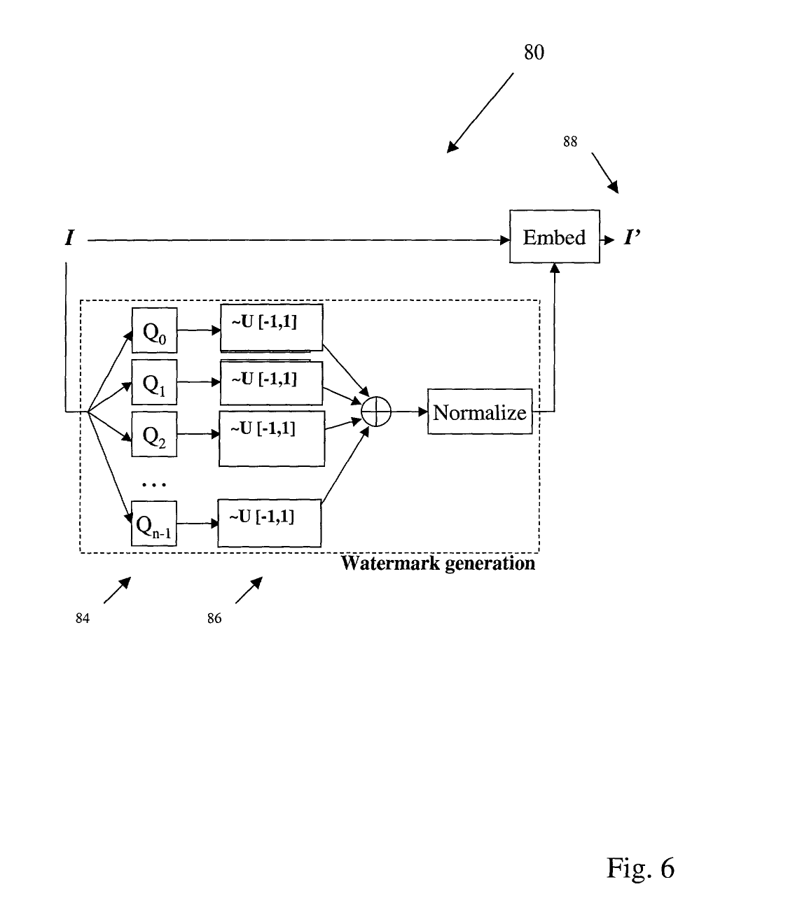

Quantization-based methods also allow for semi-fragile watermarks. For example, bounded distortion authentication watermarks can also be used as a measure of received content quality. Image regions altered beyond specified bounds of ‘acceptability’, e.g. by packet loss or corruption, can be determined by the detector in order to evaluate overall received image quality. In certain embodiments, extent of degradation suffered by media content can be computed as a function of the image distortion. FIG. 6 illustrates such an embodiment 80, with the computed watermark being correlated with the original watermark signal if the content is undistorted, and becoming increasingly uncorrelated with increasing distortion. As seen in FIG. 6, to compute a distortion-dependent watermark the host signal is quantized with an ensemble of increasingly coarse quantizers 84, the output of each of which is used as input to a uniform pseudo-random noise generator 86 (PRNG). The PRNG input typically consists of the concatenation of the quantizer output, the PRNG number, the host signal location (e.g. DCT coefficient number or pixel location), and a private key. The outputs of the uniform PRNGs are summed and normalized to synthesize a Gaussian signal (i.e. drawn from N(0,1)), which is then taken to be the watermark signal 88 used for embedding or detection.

If the image is undistorted, all quantizers produce the same outputs in detection as were used in insertion, so the embedded/extracted watermark correlation is 1.0. However, as the image becomes increasingly distorted, depending on the quantizer bin sizes chosen, an increasing number of quantizers produce different outputs during extraction than they did during insertion, and thus the watermark signal becomes increasingly uncorrelated between the embedder and detector. The choice of the quantizers determines the robustness/sensitivity of the scheme to distortions.

In operation, this invention simplifies automatic assessment of received perceptual quality of image or audiovisual content, without necessarily requiring access to either the original uncorrupted material or any side information. Possible applications include the ability for carriers to bill users proportionally according to the perceived value of their media viewing experiences, the ability for content providers to verify that carriers are providing an adequate quality of service when delivering their content to users, or in transcoders where automated quality monitoring may be used within a feedback loop so as to ensure that certain quality bounds are maintained. As will be appreciated, this invention is not limited streaming media, but is generally applicable to a variety of present wired and emerging wireless applications.

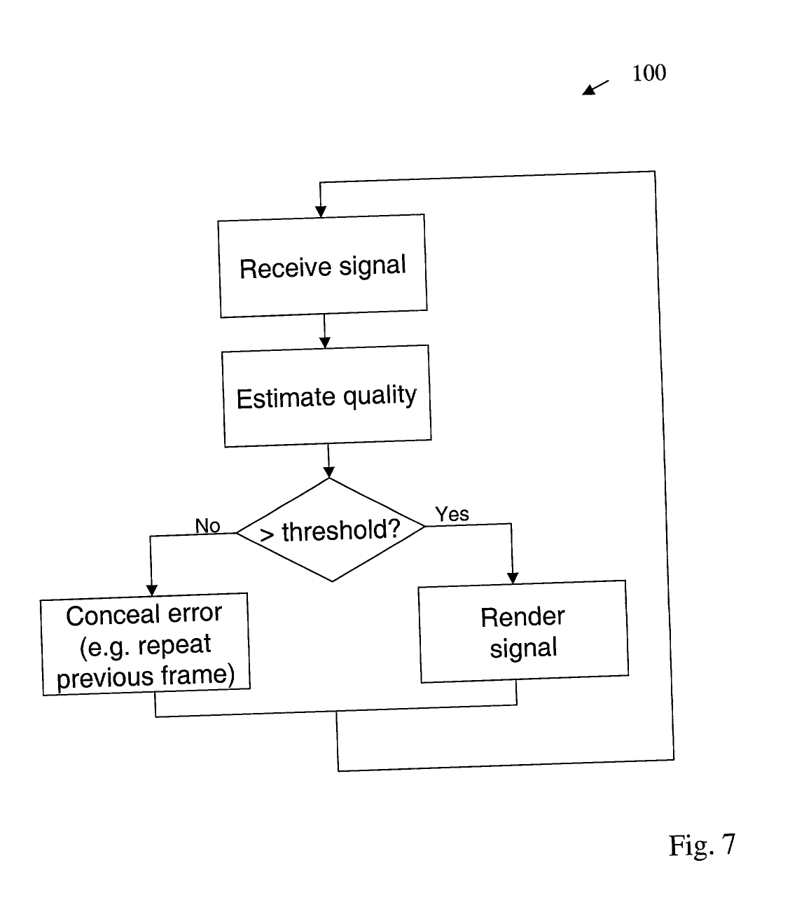

As will be understood, this invention can be used in various systems or applications. For example, one possible application uses the potential ability to automatically monitor content to reduce viewing errors. A receiver (e.g., a computer, handheld device, set top box, etc.) can be configured to monitor content quality and determine whether or not received content should be rendered. For example, as seen in FIG. 7, a system 100 supporting a DVD player that reads from a scratched DVD disc or a streaming client that receives content over a wired or wireless link can be used to automatically estimate the quality of its received content and decide to use error concealment when material is determined to be corrupted. If a corrupted signal is received, the receiver can make the determination to use error concealment, e.g. by repeating either an entire previous video or audio frame, or by replacing the region that was found to be corrupted with another signal.

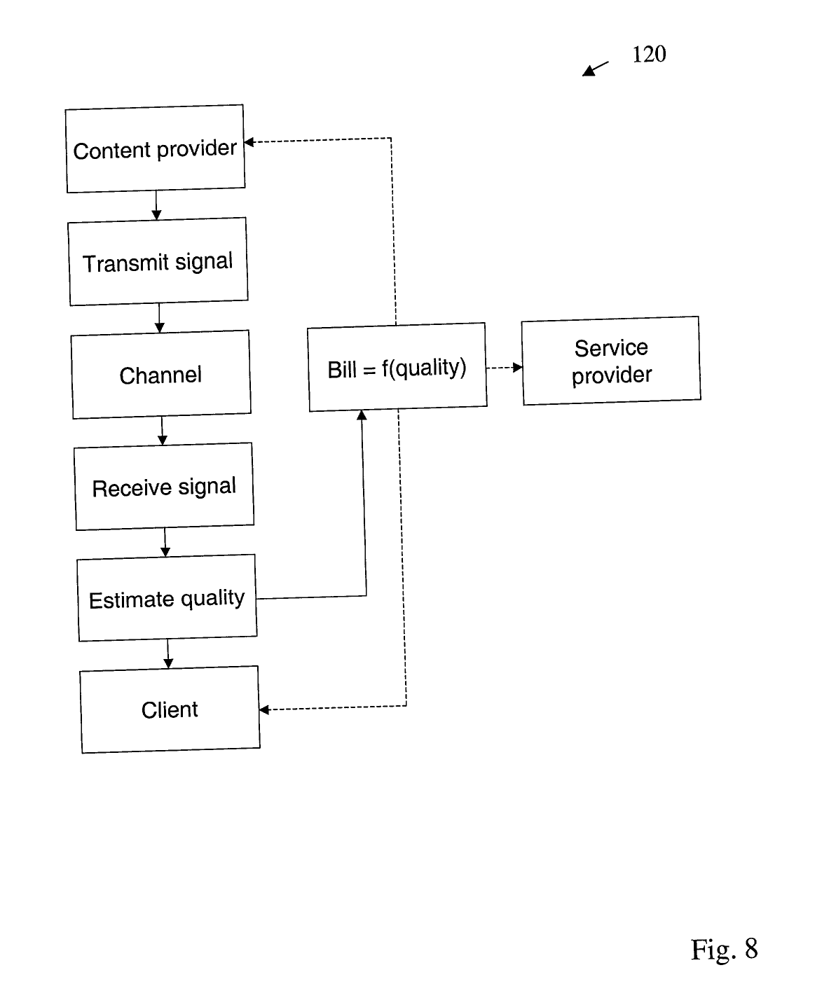

In another possible application illustrated with respect to the system illustrated by flow diagram 120 in FIG. 8, automatic quality monitoring can be used to modify billing or network quality of service parameters based on signal quality. For example, the received quality may be taken into account when the content provider and/or service provider compute how much to bill the client, so that if a lower quality is received at either an intermediate node in the network or at the client, a lower fee is charged for the service. Each party involved in the transmission of content, from the content provider through the network service provider to the end client, bills—or is billed by—others as a function of the quality of received content. For example, consider a content provider who negotiates a contract with the service provider to ensure a particular quality of service for his/her content, or a client who pays on a sliding scale according to the quality of his/her viewing experience. In both cases, quality monitoring is used as input to the billing system. As seen in FIG. 8, the content generator transmits a signal along a communication for reception and evaluation of signal quality. At a varying rate determined as a function of the received signal quality, the client is billed by the content provider/service provider.

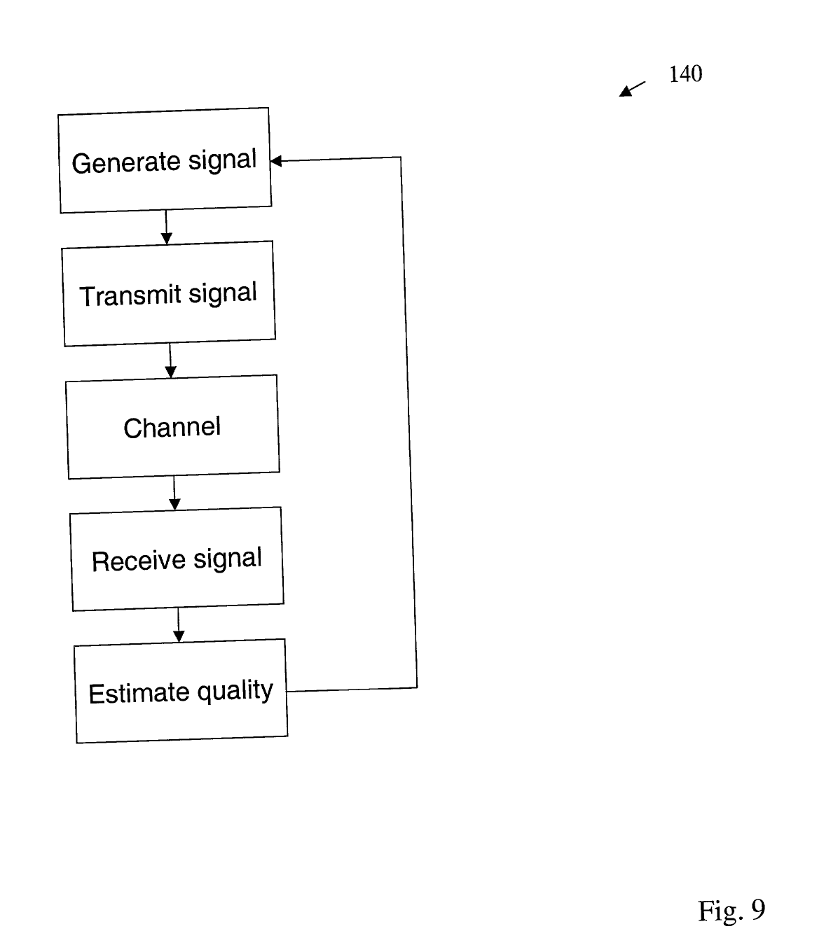

In another application illustrated with respect to the flow diagram 140 in FIG. 9, automatic quality monitoring is used as part of a feedback channel to modify encoding and/or transmission parameters in real-time. For example, if the client receives a high-quality signal, there are few losses in the channel, so the source further increases the quality of the signal it sends. On the other hand, if the client receives a low-quality signal, the source adaptively switches to a lower bit-rate stream, or uses stronger error correction techniques to compensate for the lossy channel. As seen in FIG. 9, a signal is generated, transmitted through a channel to a node in the network, (i.e. an intermediate node or the eventual client) that receives and estimates the signal quality. The estimated quality is used in a feedback channel to adjust parameters of transmission by the signal generator. If the received quality is estimated to be lower than some threshold, the source may encode and/or transmit a lower bit-rate stream, send fewer enhancement layers when sending an MPEG-4 Fine Granularity Scalability (FGS) stream, or use additional error correction to improve signal quality. Conversely, if the received quality is larger than some threshold, a higher bit-rate stream may be sent or less error correction used during transmission.

Software implementing the foregoing methods, encoders, and decoders described above can be stored in the memory of a computer system (e.g., set top box, video recorders, etc.) as a set of instructions to be executed. In addition, the instructions to perform the method, encoders, and decoders as described above could alternatively be stored on other forms of machine-readable media, including magnetic and optical disks. For example, the method of the present invention could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the methods, encoders, and decoders as discussed above, could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc. Furthermore, the encoders and decoders as described above could be implanted on the same hardware component, such as a graphics controller that may or may not be integrated into a chipset device.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may” “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Accordingly, it is the following claims including any amendments thereto that define the scope of the invention.

What is claimed is:

1. A method of
embedding a watermark in a data set,
processing the data using some parameter set,
determining presence of data corruption of the data set with respect to an original data set by measuring the amount of a recovered watermark, and
adjusting the parameter set for the data processing based on the presence of data corruption.

2. The method of claim 1, further comprising processing the data set by transform encoding the data set.

3. The method of claim 1, further comprising processing the data set by packetizing and transmitting the data set.

4. The method of claim 1, further comprising identifying image frame errors in packet transmitted audiovisual data sets.

5. The method of claim 1, wherein adjusting the parameter set further comprises modifying network bandwidth to compensate for data corruption of the data set.

6. The method of claim 1, wherein determining presence of data corruption further comprises quantitatively measuring spatial extent of corruption of image data sets.

7. The method of claim 1, wherein determining presence of data corruption further comprises quantitatively measuring temporal duration of corruption of data sets.

8. An article comprising a computer readable medium to store computer executable instructions, the instructions defined to cause a computer to
embed a watermark in a data set,
process the data using some parameter set,
determine presence of data corruption in the data set with respect to an original data set by measuring the amount of a recovered watermark, and
adjust the parameter set for the data processing based on the presence of data corruption.

9. The article comprising a computer readable medium to store computer executable instructions of claim 8, wherein the instructions further cause a computer to process the data set by transform encoding the data set.

10. The article comprising a computer readable medium to store computer executable instructions of claim 8, wherein the instructions further cause a computer to process the data set by packetizing and transmitting the data set.

11. The article comprising a computer readable medium to store computer executable instructions of claim 8, wherein the instructions further cause a computer to identify image frame errors in packet transmitted audiovisual data sets.

12. The article comprising a computer readable medium to store computer executable instructions of claim 8, wherein the instructions further cause a computer to adjust the parameter set by modifying network bandwidth to compensate for data corruption of the data set.

13. The article comprising a computer readable medium to store computer executable instructions of claim 8, wherein the instructions further cause a computer to determine presence of data corruption by quantitatively measuring spatial extent of corruption of image data sets.

14. The article comprising a computer readable medium to store computer executable instructions of claim 8, wherein the instructions further cause a computer to determine presence of data corruption by quantitatively measuring temporal duration of corruption of data sets.

15. A data degradation measurement system comprising
a watermarking module to embed a recoverable watermark in a data set,
a processing module for modifying the data using some parameter set, and
a watermark recovery module to determine presence of data corruption of the data set with respect to an original data set by measuring the amount of a recovered watermark.

16. The method of claim 15, wherein the processing module further comprises a transform encoding processor to process the data set by transform encoding the data set.

17. The method of claim 15, wherein the processing module further comprises a packetizer to process the data set by packetizing and transmit the data set.

18. The method of claim 15, wherein the watermark recovery module further detects image frame errors in packet transmitted audiovisual data sets.

19. The method of claim 15, wherein the processing module adjusts the parameter set by modifying network bandwidth to compensate for data corruption of the data set.

20. The method of claim 15, wherein the watermark recovery module quantitatively measures spatial extent of corruption of image data sets.

21. The method of claim 15, wherein the watermark recovery module quantitatively measures temporal duration of corruption of data sets.

22. The method of claim 15, further comprising a back channel transmitter to communicate information to the processing module to adjust the parameter set for the data processing based on the presence of data corruption detected by the watermark recovery module.

23. A method of
receiving an embedded watermark in a data set,
determining quality of the received data set with respect to an original data set by measuring the amount of a recovered watermark, and
adjusting determined billing value of the received data set based on the determined quality.

24. The method of claim 23, wherein adjusted billing value is partitioned between a content provider and a service provider.

25. The method of claim 23, wherein the data set is provided by a content encoder, and wherein the determined quality of the received data set is transmitted to the content encoder to permit encoding adjustments.

26. The method of claim 23, wherein the data set is transmitted by a service provider, and wherein the determined quality of the received data set is transmitted to the service provider to permit quality of service adjustments.

27. The method of claim 23, wherein the determined quality of the received data set is used to drop data frames from playback having less than a predetermined quality level.

28. A method of
embedding a watermark in a data set to allow reception-side determination of quality of the data set with respect to an original data set by measuring the amount of a recovered watermark,
transmitting the data set having the embedded watermark, and
accepting information about determined quality of the transmitted data set and adjusting at least one of a data encoding parameter or transmission parameter in response for later transmitted data.

29. A method of
embedding a watermark in an original data set,
transmitting the data set having the embedded watermark over a packet based network to a receiver,
determining quality of the received data set with respect to the original data set by measuring the amount of a recovered watermark, and
adjusting determined billing value of the received data set based on the determined quality with respect to the original data set.
